(19) United States
(12) Patent Application Publication
(10) Pub. No.: US 2008/0166926 A1
(43) Pub. Date: Jul. 10, 2008

(54) Stackable electonic blocks and a method for stacking the same

(76) Inventors: Arthur Seymour, Deerfield, IL (US); Marc Lehner, Antioch, IL (US); Alexander Matz, Wheeling, IL (US)

Correspondence Address: LAMPEL & ASSOCIATES, P.C., 555 SKOKIE BLVD., SUITE 500, NORTHBROOK, IL, 60062, US

(21) Appl. No.: 11/650,633

(22) Filed: Jan. 6, 2007

(51) Int. Cl. H01R 13/514; E04B 2/02

(52) U.S. Cl. 439/701; 52/747.12

(57) ABSTRACT

The present invention generally relates to a mechanical structure having electronic circuits that easily and quickly connect together. The mechanical structures may be building blocks which are stackable and reusable. The building blocks may be removably held together by, for example, gravity and/or friction. The building blocks have electronic circuits which may have numerous uses, including, but not limited to educational, industrial and entertainment uses. More specifically, a building block of the present invention may be insert on, and secured to, a second building block. The building blocks may be identical or may have different features which accomplish varying desired functions. For example, a building block of the present invention may have a light and/or sound feature. In addition, the circuitry of the building blocks of the present invention has unique electronic paths which prevent electronic shorts across a power source. More specifically, the electronic paths of the building blocks have diagonal spacing which may not be shorted as a result of the mechanical limitations in stacking the building blocks

### BACKGROUND OF THE INVENTION

The present invention generally relates to a mechanical structure having electronic circuits that easily and quickly connect together. The mechanical structures may be building blocks which are stackable and reusable. The building blocks may be removably held together by, for example, gravity and/or friction. The building blocks have electronic circuits which may have numerous uses, including, but not limited to educational, industrial and entertainment uses. More specifically, a building block of the present invention may be insert on, and secured to, a second building block. The building blocks may be identical or may have different features which accomplish varying desired functions. For example, a building block of the present invention may have a light and/or sound feature. In addition, the circuitry of the building blocks of the present invention has unique electronic paths which prevent electronic shorts across a power source. More specifically, the electronic paths of the building blocks have diagonal spacing which may not be shorted as a result of the mechanical limitations in stacking the building blocks.

Building blocks have long been used for educational, entertainment and industrial purposes. Uses range from educational kits for mechanical or electrical engineering students, to toys for children to components used in assembly line production. Further, there exists many mechanical blocks being sold that can be connected to quickly assemble structures such as buildings, toys, or novel three dimensional shapes. Although most of these prior art building blocks have standard spacing for mechanical connections with no electronic components or circuits associated with the building block, there has been a few building blocks which incorporate circuits on a modular housing for ease of assembly. These modular housings, however, are not designed to build mechanical structures as is provided in the present invention. Further, these existing building blocks do not provide the novel circuitry paths of the present invention which eliminate the possibility of the circuitry shorting out.

A need, therefore, exists for an improved mechanical structure having electronic circuits which overcomes the existing mechanical building structures. More specifically, a need exists for an improved building block which has the unique circuitry as described herein.

### SUMMARY OF THE INVENTION

This invention consists of a standard building block combined with a unique conductive path and electronic components that allow the construction of mechanical structures that also contain electronic circuits that perform many different and exciting functions. A building block of the present invention may be removably attached to a second building block, either identical or non-identical, by means of protruding cylinders located on the top of the building blocks. This new electronic building block incorporates connectors designed to match existing non-electronic building blocks in order to build structures that are mechanically the same as with standard building blocks and still contain electronic circuits. As a result, a non-electronic building block may be removably connected to a building block containing electrical circuitry.

Many of the quick connect electronic assembly systems currently being sold consist of a box of electronic devices mounted to quick connect bases. Diagrams for hundreds of circuits are often included to educate a student and/or entertain a child. When these circuits are assembled properly, the builder can listen to a radio station, send a flying saucer on a mission, create and store sounds, just to name a few. However, these quick connect systems are generally not suitable for building mechanical structures. In addition, these quick connect systems generally do not interface with most of the standard building blocks on the market today.

In the toy and educational fields, you can also find different building blocks that allow the construction of unique mechanical shapes. These blocks are designed to build fairly complex structures with special shaped blocks that add features such as windows, wheels, roof tops, and door ways to name only a few. However, these blocks are not designed to make electronic connections to electronic components during the construction of a wall or other mechanical structure.

By designing a building block that contains a unique electronic path with electronic components and/or circuits inside the block, it is possible to combine the features of each system into a new system with extended advantages. As a result, power supplies, motors, power transistors, movable wheeled bases, blinking lights, music circuits, and many other controlled circuit devices may be integrated smoothly and almost invisibly with many of the complex mechanical designs and structures. The unique electronic path prevents electronic shorts across the power source no matter how the block is mechanically connected due to diagonal spacing of the two electronic paths. In addition, the circuits inside the blocks are electronically designed to work properly even if the power input to the block is reversed. The unique circuitry of the present building block allows all the circuits inside the blocks to become electronically paralleled as soon as the blocks are mechanically connected together. When a power source building block is added to any structure and activated, all the electronic building blocks in the structure instantly receive power. Since the circuits are all electronically paralleled by the unique conductive path, the removal of any building block will not affect the function of the other building blocks still connected to the power source block.

In the preferred embodiment a conductive building block is provided having at least four electrical connection areas arranged in a substantially square configuration; a first conductive path connecting one of the electrical connection areas to a second electrical conductive area wherein the first conductive path is substantially diagonal with respect to the four electrical connection areas; and a second conductive path connecting a third electrical connection area to a fourth electrical connection area wherein the second path is substantially diagonal and wherein the first path and the second path are substantially perpendicular to each other.

In an embodiment, the conductive building block has at least one of the electrical connection areas which is a mechanically female connection area which may be mechanically and electrically connected to a corresponding male connection area which is not located on the conductive building block.

In an embodiment, the conductive building block has at least one of the electrical connection areas which is a mechanically male connection area which may be mechanically and electrically connected to a corresponding female connection area which is not located on the conductive building block.

In an embodiment, either the first conductive path or second conductive path is located substantially on a top surface of the building block and wherein the remaining conductive path is located substantially within an interior of the building block.

In still another embodiment, the first conductive path and second conductive path overlap without shorting out either path.

In yet another embodiment, the first conductive path and second conductive path are electronically distinct.

In still another embodiment, the first conductive path and second conductive path are a plated metal such as copper, nickel, or tin.

In an embodiment, the first conductive path and second conductive path are created by selectively spraying a conductive substance such as paint or ink onto the building block.

And in a further embodiment, the first conductive path and second conductive path are created by gluing on a conductive metallic foil or conductive paper onto the block.

In an embodiment, the first conductive path and second conductive path are created by inserting metal stamping or clips onto the building block.

In yet another embodiment, the male connection areas have a generally cylindrical shape and are located on a top surface of the building block.

In an embodiment, the female connection areas occupy a space located within an interior of the building block.

In an embodiment, a male connection area of the block is designed to fit into a female connection area of a second block.

In yet another embodiment, the building block has an electronic circuit electrically connected between the two non-shorting diagonal conductive paths.

In still another embodiment, the conductive area is electronically attached to a printed circuit board without the use of solder.

In an embodiment, the printed circuit board has circuitry which produces music, mechanical rotation, light, sounds, speech, or AC voltage.

In an embodiment, the building block has an enclosed rotational device with associated circuitry or hardware wherein the rotational device produces rotation of a portion of the building block in only one direction regardless of the polarity of the voltage applied to the conductive paths.

In an embodiment, the rotation is produced by a DC motor connected to a diode bridge.

In an embodiment, the building block has an enclosed device with associated circuitry to produce music or speech regardless of the polarity of the voltage applied to the conductive paths.

In yet another embodiment, the building block has a short circuit and high current protection device connected to the conductive area.

In an embodiment, the building block has an automatic turn off to conserve power connected to the conductive area.

In still another embodiment, the building block has a DC to AC converter connected to the conductive area

In an embodiment, the conductive material is nonmetallic.

In an embodiment, the male conductive surface protrudes above a top surface of the building block.

A method is provided for stacking conductive building blocks comprising the steps of: providing a first building block having at least four electrical connection areas arranged in a substantially square configuration; providing a first conductive path connecting one of the electrical connection areas to a second conductive areas wherein the first conductive path is substantially diagonal with respect to the four connection areas; providing a second conductive path connecting a third electrical connection area to a fourth electrical connection area wherein the second path is substantially diagonal and wherein the first conductive path and second conductive path are substantially perpendicular to each other; providing a second building block having at least four electrical connection areas arranged in a substantially square configuration, a first conductive path connecting one of the electrical connection areas to a second conductive areas wherein the first conductive path is substantially diagonal with respect to the four connection areas, a second conductive path connecting a third electrical connection area to a fourth electrical connection area wherein the second path is substantially diagonal and wherein the first conductive path and second conductive path are substantially perpendicular to each other; providing at least one male connection surface on the first block and at least one female connection surface on the second block; and mechanically preventing the attachment of the first block to the second block in a manner which would allow any of the conductive paths to be shorted.

In an embodiment of the method, the method has the further steps of: providing a power source associated with the first building block and second building block; and removing the second building block from the first building block wherein removal of the second building block does not interrupt the power current to the first building block.

A conductive building block is also disclosed having: a top side having an edge; at least four electronically conductive areas on the top side arranged in a substantially square configuration; providing a first conductive path connecting at least two of the electronically conductive areas wherein the first electronically path covers a portion of the edge of the top side; providing a second conductive path connecting a third electronically conductive area to a fourth electrically conductive area wherein the second conductive does not overlap with the first conductive path; and providing a male or female mechanically connection area wherein the male or female mechanically connection area connects to a corresponding connection area on a different surface and wherein the male or female mechanical connection area establishes an electrical communication with the corresponding connection area on the different surface.

For a more complete understanding of the above listed features and advantages of the stackable electronic building blocks, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

The objects and advantages of the present invention will become more readily apparent to those ordinarily skilled in the art after reviewing the following detailed description and accompanying drawings, wherein:

FIG. 1 illustrates a perspective view of the top surface of a conductive building block of the present invention wherein the building block has mechanical stackable cylinders.

FIG. 2 illustrates a bottom perspective view of a building block of the present invention showing the diagonal conductive path circuitry.

FIG. 3 illustrates a straight on view of the bottom of the building block of the present invention showing the diagonal conductive path circuitry.

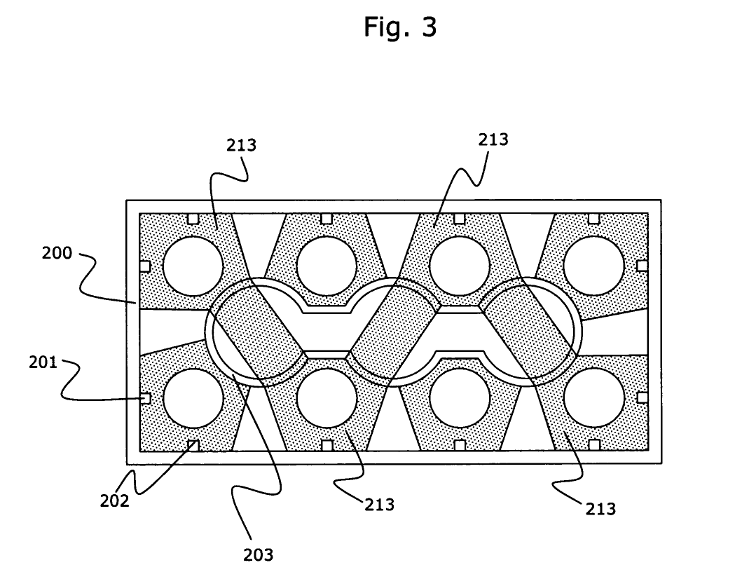

FIG. 4 illustrates a perspective view of the bottom of the building block of the present invention wherein an electronic circuit board is visible.

FIG. 5 illustrates an electronic schematic of a building block of the present invention.

FIG. 6 illustrates a perspective view of a constructed wall that uses standard non-conductive building blocks and the conductive building blocks of the present invention and further illustrating some of the possible functions in which the conductive building blocks may carry out.

FIG. 7 illustrates a schematic diagram of each conductive building block in the wall of FIG. 6.

FIG. 8 illustrates a schematic for the Current Limit Circuit & Short Circuit Protection section, voltage reversing circuit & timer, and time out circuit, section used in battery conductive building block.

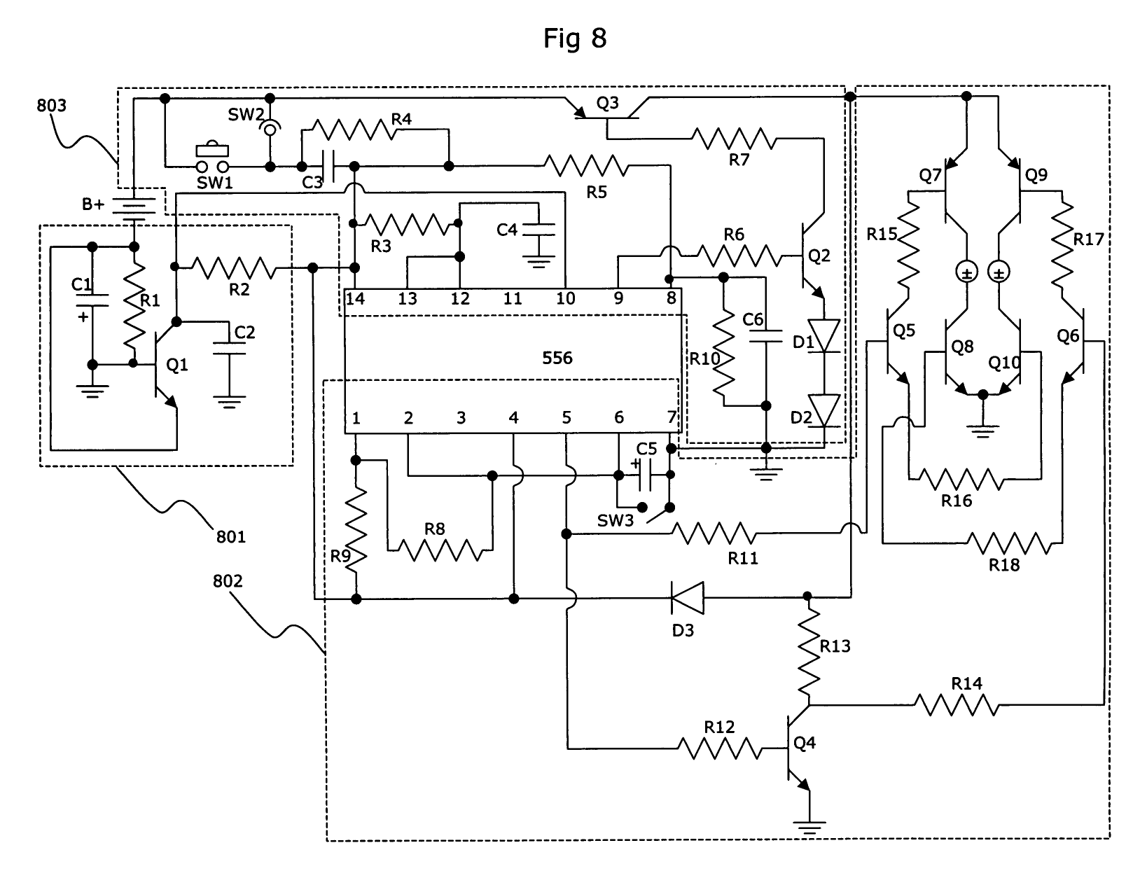

FIG. 9 illustrates a perspective view of the top surface of a conductive building block showing the edge conductive path circuitry.

### DETAILED DESCRIPTION OF THE PREFERRED EMBODIMENTS

The present invention generally relates to a mechanical structure having electronic circuits that easily and quickly connect together. The mechanical structures may be building blocks which are stackable and reusable. The building blocks may be removably held together by, for example, gravity and/or friction. The building blocks have electronic circuits which may have numerous uses, including, but not limited to educational, industrial and entertainment uses. More specifically, a building block of the present invention may be insert on, and secured to, a second building block. The building blocks may be identical or may have different features which accomplish varying desired functions. For example, a building block of the present invention may have a light and/or sound feature. In addition, the circuitry of the building blocks of the present invention has unique electronic paths which prevent electronic shorts across a power source. More specifically, the electronic paths of the building blocks have diagonal spacing which may not be shorted as a result of the mechanical limitations in stacking the building blocks.

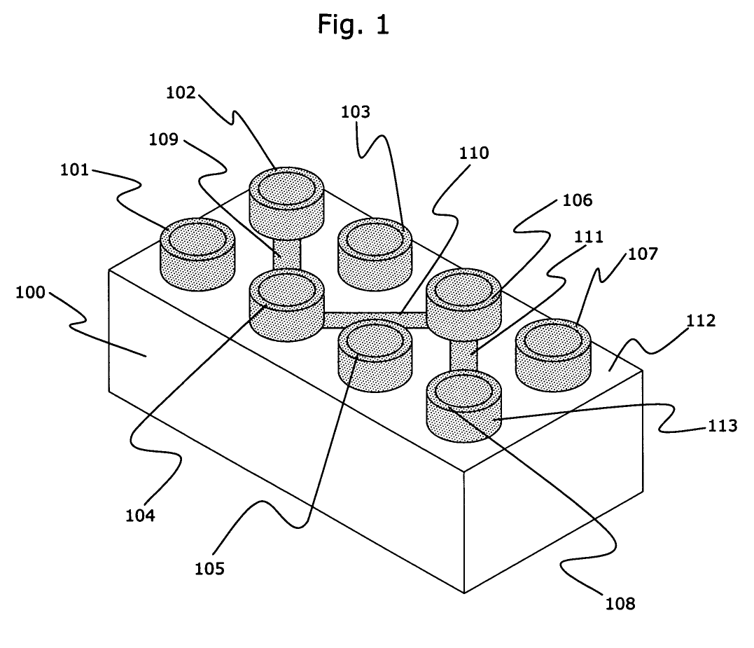

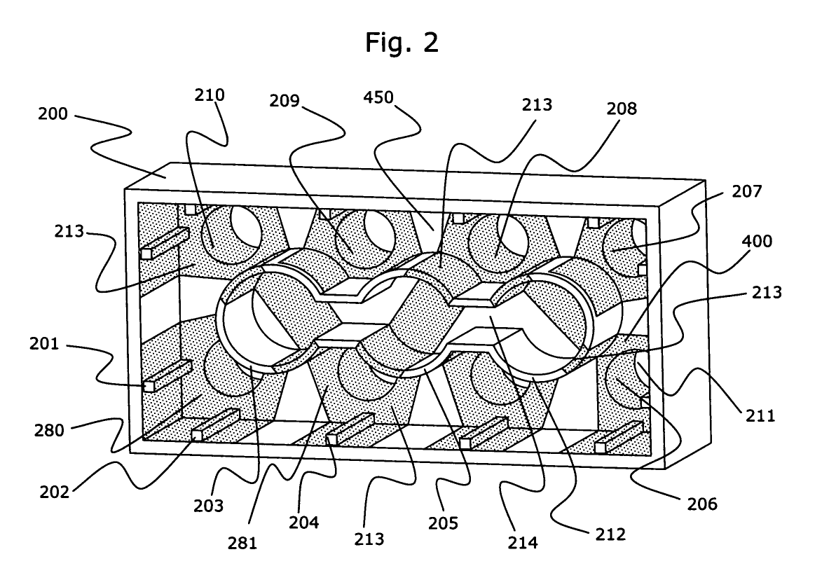

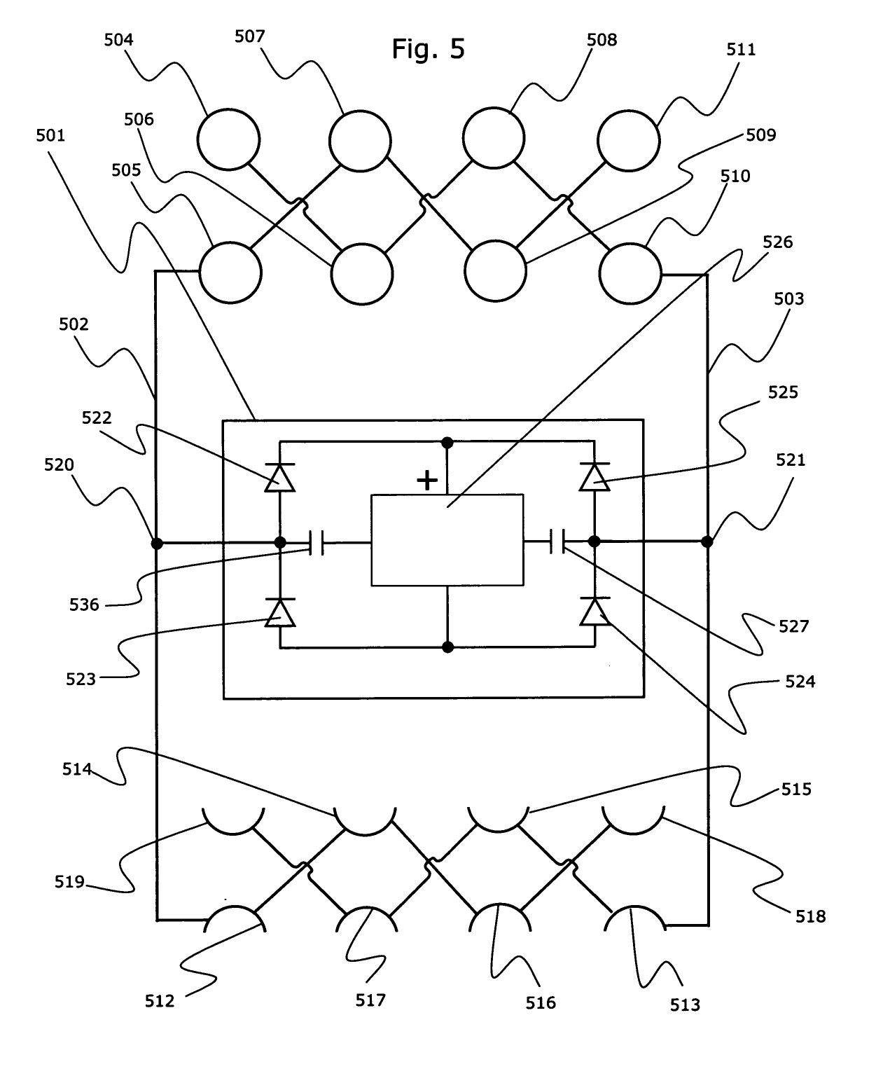

The present invention consists of an improved building block 100 that contains mechanical cylinders 101-108 which may be conductive. The mechanical cylinders 101-108 may be located on a top surface 112 of the building block 100. FIG. 1 illustrates eight mechanical cylinders 101-108 located on the top surface 112 of the building block 100, however, it should be understood that the number of mechanical cylinders 101-108 located on the top surface 112 of the building block 100 may vary. Conductive paths 109-111, 213 (FIG. 2), 502, 503 (FIG. 5) may be located on, for example, the top surface 112 of the building block 100 and/or located inside the building block 100. More specifically, a first conductive path 109-111 may be located above the top surface 112 of the building block 100 and a second conductive path 213 may be located, for example, on an underside 450 of the top surface 112 of the building block 100. As a result, there may be two separate conductive paths which are not in electrical communication.

The mechanical cylinders 101-108 are designed to fit snuggly into a bottom opening 211 of the building block 100 for building mechanical structures. More specifically, the mechanical cylinders 101-108 of the building block 100 may be secured to the bottom opening 211 of another building block 100 by, for example, gravity and/or friction. The cylinder 102 is shortened to cylinder 104 by a conductive material 109. Cylinder 104 is shortened to cylinder 106 by a conductive material 110. Cylinder 106 is shortened to cylinder 108 by conductive material 111. The above listed conductive material 109-111 may be a metallic or non-metallic material. Common metallic conductive materials which may be used in the building blocks 100 include, but are not limited to, copper, silver, aluminum, steel, gold, nickel or a tin/lead alloy. Preferably, nickel is used as a cost saving mechanism and/or to reduce corrosion. Non-metallic conductive materials which may be used in the building blocks 100 include plasmas.

In this manner the diagonally related cylinders 102, 104, 106, and 108 are electronically shorted together. All the cylinders 101-108 on the top surface 112 of the building block 100 are coated or made with a conductive material 113. As illustrated in FIG. 2, a second building block 100 may be inserted into an area 280 between rib 201, rib 202, and the lower internal large cylinder wall 203. The area 280 produces a space which snuggly holds the cylinder 101-108 from the top of other building blocks 100 similar to the conductive building block 100 shown in FIG. 1. In a similar manner, the spacing between rib 204 and large cylinder walls 203 and 205 produces an area 281 to snuggly hold cylinders 101-108 from the top of blocks similar to the conductive building block 100 shown in FIG. 1. The cylinders 101-108 of the building block 100 may have an interior wall 206 (FIG. 2). The bottom view and inside of cylinder wall 206 shows the opening 211 to the top of the block 100 through cylinder 107. A conductive material 213 creates an electrical path through cylinder 206 to the top of the block 100 and around cylinder 107.

FIG. 2 shows the bottom view of the building block 100 and inside of the cylinder walls 207-210. A conductive material 213 creates an electrical path 400 through all the interior large cylinders 203, 205, 212 that shorts cylinders on the top surface 112 of the building block 100 located diagonally from each other, staring with cylinder 107 shown in FIG. 1. This produces a short between cylinders 107, 105, 103, 101 located on the top surface 112 of the conductive building block 100. There is no short, however, between the group of cylinders 107, 105, 103, 101 located diagonally from each other and the other diagonally shorted group 102, 104, 106, 108 shown on the top surface 112 of the building block 100. Inside each conductive building block 100 there is a compartment 214 in which electronic circuit boards or components can be placed.

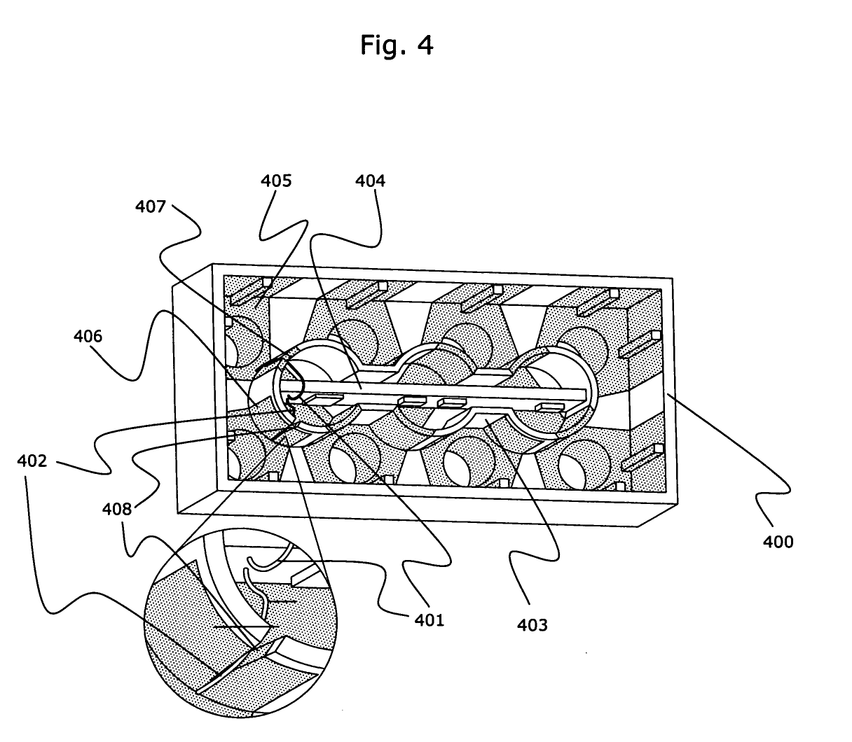

The conductive building blocks 100 are designed to mechanically accept, hold in place, and make electronic contact to the leads 401, 402 (FIG. 4) attached to an electronic circuit board(s) 404. The leads 401, 402 of the electronic circuit board 404 are connected to conductive paths 405, 406 by being pressed into slots 407, 408 which are also part of the conductive paths 405, 406 respectively. More specifically, when a bottom 450 of one of the conductive building blocks 100 is placed onto the top surface 112 of another building block 100 the conductive paths 405 and 406 become electronically connected to the conductive paths 405 and 406 of the other block.

The conductive path 109-111, 213 of one building block 100 may be spaced to prevent shorting to the other conductive path 213, 109-111 of a second building block 100. The conductive paths 109-111, 213 on any single building block 100 can be connected to either conductive path 109-111, 213 of another different building block 100. If a positive voltage is connected to one of the conductive paths 109-111 and a negative voltage is connected to the other path 213 of the power source building block 602, the positive voltage can never be shorted to the negative voltage during normal assembly due to the diagonal spacing. The positive and negative voltage on any single conductive block 100 may be interchanged by the way it is connected to another conductive block 100.

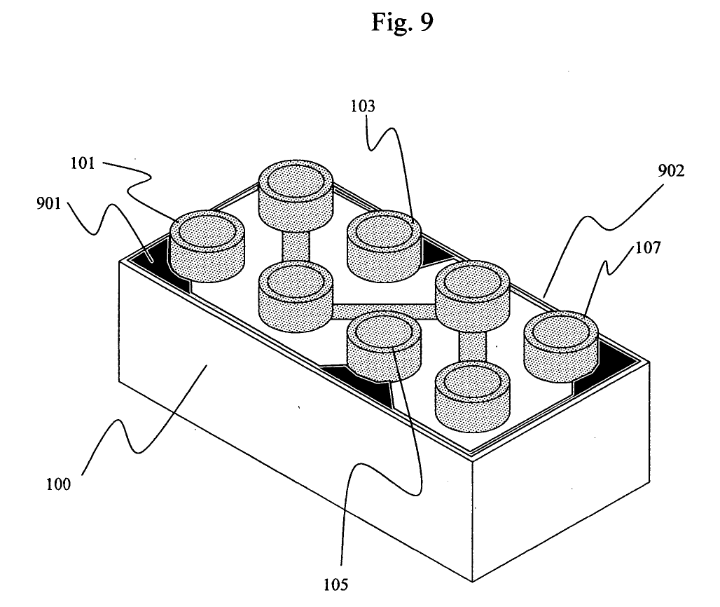

The conductive path 213 of the building block 100 could be replaced with a conductive path 901 (see FIG. 9) that uses the edge 902 of the building block 100 to connect diagonally spaced cylinders 101, 103, 105, 107 without shorting to paths 109-111.

Conductive building blocks 100 may have both upper conductive cylinders 101-108, 504-511, used as the male electronic connectors and lower receiving areas 201-203, 512-519 used as female electronic connectors. The upper conductive cylinder 101-108, 504-511 may be conductively connected to the lower female electronic connector 512-519 directly below it in the conductive building block 100 and to one of the conductive paths 502,503. In this manner the conductive paths 502, 503 are passed from one conductive block 100 to another conductive block 100 when they are assembled as a structure or wall.

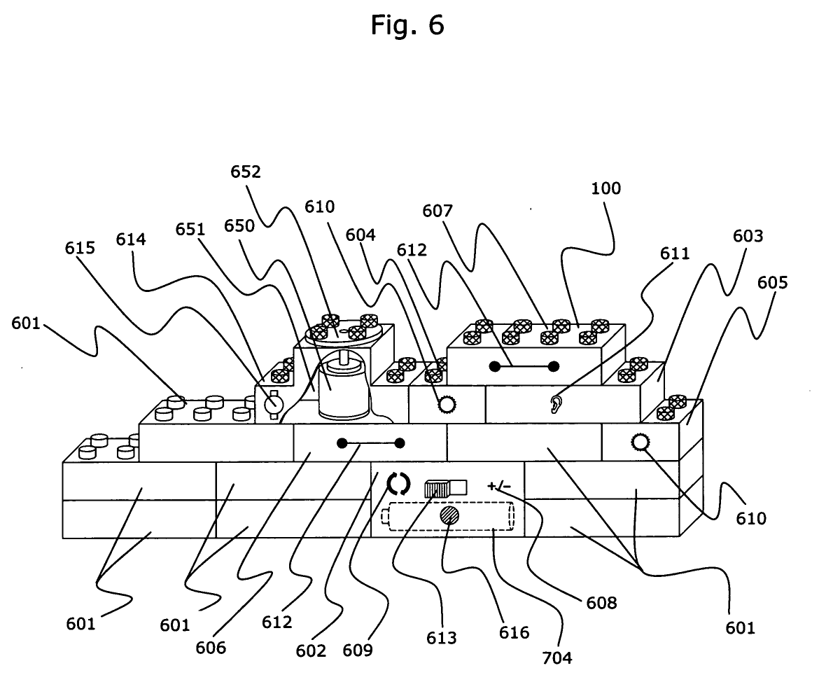

FIG. 6 shows a wall made with both non-conductive building blocks 601, and conductive building blocks 100. The conductive building blocks 100 may be modified to contain, for example, batteries 602; electronic circuit boards 404 (FIG. 4) that make, for example, music 603, sources of light 604, 605; conductive paths 606, 607; and a motor 614. Indicia, such as a symbol, 608-612 may be displayed on the conductive blocks 602-607 to show which circuit is contained within the building block 602-607. For example, building block 614 illustrates the symbol 615 of a motor indicating that a motor 650 is located within an interior 651 of building block 614. The motor 650 may, for example, produce a rotation of a circular top 652 of the motor block 614.

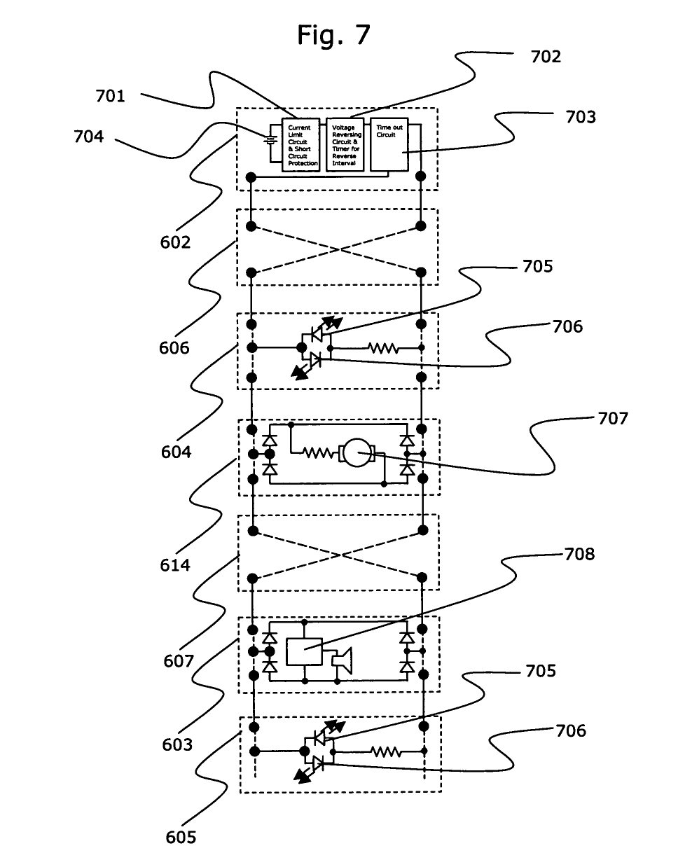

A switch 613 on a battery block 602 may change the output between fixed DC out 608 or AC output 609. FIG. 7 shows a schematic diagram of each conductive building block 100 in the wall built using building blocks 602-607 and the motor block 614. The conductive battery block 602 also contains a Current Limiting Circuit and Short Circuit Protection 701, a voltage reversing circuit & timer for making alternating current (AC) 702, and a time out circuit section 703. The DC power source or battery 704 must also be contained inside the battery conductive building block 602.

Referring now to FIG. 5, a schematic is illustrated of a conductive building block 100 containing an electronic circuit board 404 (FIG. 4), 501; top to bottom conductive paths 502, 503; male contact cylinders 505, 507, 509, 511 connected to one top to bottom path 502; male contact cylinders 504, 506, 508, 510 connected to the other top to bottom path 503; female contact area 512, 514, 516, 518 connected to one top to bottom path 502; female contact area 513, 515, 517, 519 connected to the other top to bottom path 503; and circuit board 501 connections to the two top to bottom conductive paths 520, 521. FIG. 5 also contains a schematic of a bridge circuit made from four diodes 522-525 that insure the voltage will always be positive at the plus point for electronic circuit area 526. FIG. 5 shows two capacitors 536, 527 that couple AC signals for data communication from circuit area 526 back to the conductive paths 502, 503.

Some circuit boards 501 inside each conductive building block 100 must be connected to the conductive paths 502, 503 by using an electronic bridge 522-525 to insure the proper voltage polarity for the circuit area 526. A motor 707 must also use a diode bridge 522-525 to insure continued rotation when the voltage source reverses during assembly or an AC voltage source is used. Digital circuits that produce speech or music 708, must be connected through a diode bridge 522-525, to insure the music or data is continuous when the voltage source reverses. The circuit board 501 may also be connected to the conductive paths 502, 503 using AC devices such as a capacitor 536, 527 to transmit modulated frequencies from one conductive building block 100 to another conductive building block 100. These modulated frequencies may be used, but are not limited to, synchronizing flashing lights, transmit audio message or music, control motors, or connect to computers for data downloads.

A conductive building block 100 may be constructed from transparent or translucent materials and used as a source of light 604, 605. If the light source is two different colored back to back light emitting diodes 705, 706, then the color of the block will change when the battery block 602 changes polarity. By using many different colored light sources the visual affect can be enhanced.

The battery conductive block 602 houses the battery 704, protection circuitry 701, 801, voltage reversing circuitry 702, 802, and turn on/off circuits 703, 803. Resistor R1 and capacitor C1 are used to sense the average DC current. If the level of the average DC current exceeds a preset limit, transistor Q1 pulls pin 10 of the 556 Timer circuit to ground and resets the timer output to zero. This results in a shut down of transistors Q2 and Q3 and the voltage output is turned off. The power output can be turned on by pressing the push button switch SW1 616, or shaking the block to activate the vibration switch SW2. Under normal output power conditions, the power will remain on for a preset period determined by resistor R3 and capacitor C4 and then shut off. When power is on and switch SW3 613, is open the output polarity at the ± terminals will reverse periodically. The period for reversal is set by resistors R8, R9, the capacitor C5, and timer integrated circuit 556 used as an astable multivibrator. Transistors Q4 through Q10 are used to switch polarity at the outputs each time the multivibrator switches states. When SW3 613, is closed the output will be a constant DC.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

I claim:

1) A conductive building block comprising:
at least four electrical connection areas arranged in a substantially square configuration;
a first conductive path connecting one of the electrical connection areas to a second electrical conductive area wherein the first conductive path is substantially diagonal with respect to the four electrical connection areas; and
a second conductive path connecting a third electrical connection area to a fourth electrical connection area wherein the second path is substantially diagonal and wherein the first path and the second path are substantially perpendicular to each other.

2) The conductive building block of claim 1 wherein at least one of the electrical connection areas is a mechanically female connection area which may be mechanically and electrically connected to a corresponding male connection area which is not located on the conductive building block.

3) The conductive building block of claim 1 wherein at least one of the electrical connection areas is a mechanically male connection area which may be mechanically and electrically connected to a corresponding female connection area which is not located on the conductive building block.

4) The building block of claim 1 wherein either the first conductive path or second conductive path is located substantially on a top surface of the building block and wherein the remaining conductive path is located substantially within an interior of the building block.

5) The building block of claim 1 wherein the first conductive path and second conductive path overlap without shorting out either path.

6) The building block of claim 1 wherein the first conductive path and second conductive path are electronically distinct.

7) The building block of claim 1 wherein the first conductive path and second conductive path are a plated metal such as copper, nickel, or tin.

8) The building block of claim 1 wherein the first conductive path and second conductive path are created by selectively spraying a conductive substance such as paint or ink onto the building block.

9) The building block of claim 1 wherein the first conductive path and second conductive path are created by gluing on a conductive metallic foil or conductive paper onto the block.

10) The building block of claim 1 wherein the first conductive path and second conductive path are created by inserting metal stamping or clips onto the building block.

11) The building block of claim 3 wherein the male connection areas have a generally cylindrical shape and are located on a top surface of the building block.

12) The building block of claim 2 wherein the female connection areas occupy a space located within an interior of the building block.

13) The building block of claim 3 wherein a male connection area of the block is designed to fit into a female connection area of a second block.

14) The building block of claim 1 wherein further comprising:
an electronic circuit electrically connected between the two non-shorting diagonal conductive paths.

15) The building block of claim 1 wherein the conductive area is electronically attached to a printed circuit board without the use of solder.

16) The building block of claim 15 wherein the printed circuit board has circuitry which produces music, mechanical rotation, light, sounds, speech, or AC voltage.

17) The building block of claim 1 further comprising:
an enclosed rotational device with associated circuitry or hardware wherein the rotational device produces rotation of a portion of the building block in only one direction regardless of the polarity of the voltage applied to the conductive paths.

18) The building block of claim 17 wherein the rotation is produced by a DC motor connected to a diode bridge.

19) The building block of claim 1 further comprising:
an enclosed device with associated circuitry to produce music or speech regardless of the polarity of the voltage applied to the conductive paths.

20) The building block of claim 1 further comprising:
a short circuit and high current protection device connected to the conductive area.

21) The building block of claim 1 further comprising:
an automatic turn off to conserve power connected to the conductive area.

22) The building block of claim 1 further comprising:
a DC to AC converter connected to the conductive area

23) The building block of claim 1 wherein the conductive material is nonmetallic.

24) The building block of claim 1 wherein the male conductive surface protrudes above a top surface of the building block.

25) A method for stacking conductive building blocks comprising the steps of:
providing a first building block having at least four electrical connection areas arranged in a substantially square configuration;
providing a first conductive path connecting one of the electrical connection areas to a second conductive areas wherein the first conductive path is substantially diagonal with respect to the four connection areas;
providing a second conductive path connecting a third electrical connection area to a fourth electrical connection area wherein the second path is substantially diagonal and wherein the first conductive path and second conductive path are substantially perpendicular to each other;
providing a second building block having at least four electrical connection areas arranged in a substantially square configuration, a first conductive path connecting one of the electrical connection areas to a second conductive areas wherein the first conductive path is substantially diagonal with respect to the four connection areas, a second conductive path connecting a third electrical connection area to a fourth electrical connection area wherein the second path is substantially diagonal and wherein the first conductive path and second conductive path are substantially perpendicular to each other;
providing at least one male connection surface on the first block and at least one female connection surface on the second block; and
mechanically preventing the attachment of the first block to the second block in a manner which would allow any of the conductive paths to be shorted.

26) The method of claim 25 further comprising the steps of;
providing a power source associated with the first building block and second building block; and
removing the second building block from the first building block wherein removal of the second building block does not interrupt the power current to the first building block.

27) A conductive building block comprising:
a top side having an edge;
at least four electronically conductive areas on the top side arranged in a substantially square configuration;
providing a first conductive path connecting at least two of the electronically conductive areas wherein the first electronically path covers a portion of the edge of the top side;
providing a second conductive path connecting a third electronically conductive area to a fourth electrically conductive area wherein the second conductive does not overlap with the first conductive path; and
providing a male or female mechanically connection area wherein the male or female mechanically connection area connects to a corresponding connection area on a different surface and wherein the male or female mechanical connection area establishes an electrical communication with the corresponding connection area on the different surface.
